(19) United States
(12) Patent Application Publication
(10) Pub. No.: US 2023/0069405 A1
(43) Pub. Date: Mar. 2, 2023

(54) ROTARY DAMPER DEVICE

(71) Applicant: Schaeffler Technologies AG & Co. KG, Herzogenaurach (DE)

(72) Inventors: Ralf Edl, Achern (DE); Stefen Prestel, Karlsruhe (DE)

(73) Assignee: Schaeffler Technologies AG & Co. KG, Herzogenaurach (DE)

(21) Appl. No.: 17/797,534

(22) PCT Filed: Jan. 29, 2021
(86) PCT No.: PCT/DE2021/100088

§ 371 Date: Aug. 4, 2022

(30) Foreign Application Priority Data
Feb. 28, 2020 (DE) 10 2020 105 255.3

(51) Int. Cl. F16H 57/00; F16D 3/12; F16H 1/10; F16H 57/12

(52) U.S. Cl. CPC F16H 57/0006; F16D 3/12; F16H 1/10; F16H 57/12; F16H 2057/0012; F16H 2057/127

(57) ABSTRACT

A rotary damper device includes a drive component and a rotary damper upstream of the drive component. The drive component has an input gear with an external toothing and axially open cut-outs. The rotary damper has an annular carrier, a spring element arranged in the annular carrier, an output gear with an internal toothing meshed with the external toothing, and a clamping ring with a plurality of axially extending fingers engaged in the axially open cut-outs to clamp the output gear against the input gear.

### CROSS-REFERENCE TO RELATED APPLICATIONS

This application is the United States National Phase of PCT Appln. No. PCT/DE2021/100088 filed Jan. 29, 2021, which claims priority to German Application No. DE102020105255.3 filed Feb. 28, 2020, the entire disclosures of which are incorporated by reference herein.

### TECHNICAL FIELD

The present disclosure relates to a rotary damper device, including a rotary damper having an internally toothed output gear and an externally toothed drive gear of a drive component connected downstream of the rotary damper. The output gear meshes with the input gear, and the rotary damper has a plurality of spring elements arranged on an annular carrier.

### BACKGROUND

Such a rotary damper device is used, for example, within a drive train of a motor vehicle, wherein the output of the internal combustion engine is coupled to the transmission drive or the transmission input via the rotary damper device. The rotary damper device includes the actual rotary damper with a primary side or primary mass and a secondary side or secondary mass coupled to the plurality of springs. The torque generated by the internal combustion engine is introduced via the primary side via the connected crankshaft, i.e., the output of the internal combustion engine, and transmitted via the damper springs to the secondary side, which includes an internally toothed output gear which meshes with an externally toothed drive gear of the downstream drive component, i.e., the transmission, for example. This drive gear is therefore the transmission input shaft, for example.

Within such drive trains, it is also known that an additional electric machine can be connected to the drive train, which, as in a hybrid vehicle with P1 architecture, acts directly on the transmission input, for example, and is therefore coupled to it via suitable gearing. An additional torque can be introduced via this electric machine, and when the electric machine is permanently coupled to the drive train, the rotor of the electric machine is dragged along when the latter is not in operation.

As described, the torque is transmitted from the rotary damper or the secondary side of the rotary damper to the downstream drive component via the meshing of the internally toothed output gear with the externally toothed drive gear. Within this toothed connection, there is always a certain tolerance and thus always a certain amount of play, which can lead to noise occurring during operation due to a change in the flank contact within the toothed engagement. Critical operating points are, in particular, the light load states in which there is a high-frequency change in the flank contact while running through the clearance, such as when idling or when stationary charging in hybrids or when the electric machine rotor is dragged along. This means that the contact between the flanks changes within the meshing of the toothing of the broached, internally toothed hub or the internally toothed output gear and the, e.g., likewise broached, externally toothed drive gear or the transmission input shaft, with the contact of the flanks leading to noise.

### SUMMARY

The present disclosure provides a rotary damper device, in particular for a P1 hybrid architecture, in which the output of the electric machine is permanently coupled to the drive train, which is improved compared to previous designs.

The disclosure provides, in a rotary damper device of the type mentioned, that the rotary damper includes a clamping ring having a plurality of axially extending fingers that engage in axially open cut-outs on the drive gear, clamping it against the output gear.

In the rotary damper device according to the disclosure, a clamping ring is provided to generate a bias that biases the toothing engagement within the spline with play between the internally toothed output gear and the externally toothed drive gear, which is part of the rotary damper and which interacts with the drive gear. For this purpose, the clamping ring arranged on the rotary damper or on its secondary part is provided with a plurality of axially extending fingers which extend to the drive gear and engage with their ends in corresponding, axially open cut-outs on the drive gear. The design is such that the fingers are slightly bent as a result of this intervention, which means that a bending stress arises, which in turn leads to the two toothings being tensioned against one another, thus generating a bias in the circumferential direction. This means that parallel to the actual main gearing between the output gear and the drive gear there is an additional mechanical engagement, which is designed in such a way that a bias directed in the circumferential direction is generated via this additional mechanical engagement, which in turn acts on the main toothing, biasing it in the circumferential direction.

Thus, if the secondary side is connected to the drive train, i.e., if the internal toothing is pushed onto the external toothing, the fingers are simultaneously pushed into the front-side cut-outs, which leads to slight deformation of the fingers, which generates the bias.

As a result of this bias, any noise can be suppressed or significantly reduced in many operating cases, since the bias causes the flanks to not lift, or only lift to a lesser extent.

As stated, the clamping ring is part of the rotary damper and is connected there to its secondary side. In order to be able to integrate and fix the clamping ring there in a simple manner, a further development of the disclosure provides that the clamping ring has an annular flange that extends radially outwards, via which it is fastened to the carrier by means of fastening elements. As described, this support is part of the secondary side, and the arc springs are arranged or supported on it. This carrier now simultaneously serves as an assembly interface for fixing the clamping ring, which for this purpose has a corresponding annular flange extending radially outwards, in the area in which the attachment to the carrier and thus to the secondary side results. The fingers then adjoin this annular flange so as to extend axially.

The annular flange itself is expediently fixed to the carrier via a number of fastening elements, e.g., rivet or screw connections, via which the carrier is connected to the output gear. The carrier also serves as a mounting interface for the output gear, which is also part of the secondary side as described. The output gear is usually fixed to the carrier by riveted connections, but can also be screwed on. At the same time, these connections serve to fix the clamping ring or the ring flange, so that no separate attachment interfaces need to be provided for this purpose.

The fingers and the cut-outs expediently have contact surfaces directed in the circumferential direction, which contact one another in the assembled position, causing the bias. It is expedient here if the contact surfaces of the fingers and/or the contact surfaces of the cut-outs have inclined surfaces directed in the circumferential direction. Because of these inclined surfaces, it is possible for the fingers to slide off, guided on the contact surfaces, when they are pushed into the cut-outs, so that the bending torque and thus the biasing torque are generated. This simplifies the assembly, while at the same time the bias is built up.

The clamping ring itself is expediently made of spring steel and can be produced, for example, by stamping from a spring steel band and bending and connecting to the annular shape. Alternatively, it can also be made of tempered steel, depending on the amount of biasing that is desired to be generated.

Since flank changes can occur during operation as described despite the biasing, a further development of the disclosure provides that the fingers and/or the cut-outs are provided with a plastic covering at least in sections. This plastic covering, which can have a suitable softness or elasticity, serves as wear protection for the mechanical finger grip and prevents the metal fingers from striking the metal cut-out flanks. A suitable thermoplastic or thermoset or elastomer material can be used which has sufficient wear resistance, also with regard to any increased operating temperatures.

The plastic covering can be applied as a covering to the fingers and/or the cut-outs. This means that the fingers and/or the cut-outs are provided with the plastic covering in a suitable covering method. Alternatively, it is also conceivable for the plastic covering to be provided on the cut-outs in the form of a pressed-on plastic ring, which has sections lining the cut-outs. Here, therefore, an additional plastic ring is placed on the face of the drive gear, i.e., the gear input shaft, and glued there, for example, or the like, which is designed in such a way that it has corresponding sections that engage in the cut-outs.

### BRIEF DESCRIPTION OF THE DRAWINGS

The disclosure is explained below on the basis of exemplary embodiments with reference to the drawings. The drawings are schematic representations, wherein:

FIG. 1 shows a schematic diagram, in section, of a rotary damper device according to the disclosure, in a partial view,

FIG. 2 shows a perspective view of a clamping ring integrated into the rotary damper,

FIG. 3 shows a partial view of the rotary damper device from FIG. 1 during the joining of the output gear to the input gear, showing the resulting engagement of the fingers in the cut-outs,

FIG. 4 shows the arrangement from FIG. 3 in the assembled position, and

FIG. 5 shows an alternative embodiment of the arrangement from FIG. 3 with a drive gear coated on the front side.

### DETAILED DESCRIPTION

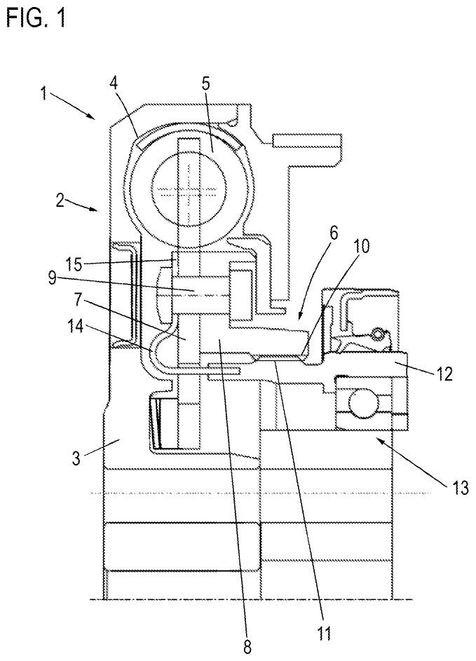

FIG. 1 shows a rotary damper device 1 according to the disclosure, including a rotary damper 2 having a primary side 3, which can also be referred to as the primary mass, to which the crankshaft of an internal combustion engine (not shown in detail) is connected, via which crankshaft the torque is introduced.

Also provided are a plurality of spring elements 5 accommodated in a suitable spring channel 4 in the form of arc springs, which extend a defined angular increment around the circumference of the spring channel 4. These spring elements 5 or arc springs are supported at one end on the primary side 3, i.e., the primary mass, and at the other end, they are coupled to the secondary side 6 or secondary mass. This secondary side 6 comprises, in a manner known per se, a carrier 7 to which the spring elements 5 are connected or which is coupled to them. Furthermore, an output gear 8 is fastened to the carrier 7 via suitable riveted connections 9, wherein this output gear 8 has an internal toothing 10 which meshes with external toothing 11 of a drive gear 12, here, for example, a transmission input shaft. The internal and external toothings 10, 11 are axial teeth that allow axial insertion into each other. The drive gear 12 is mounted on a roller bearing 13 and extends to the right in the direction of the transmission or is coupled thereto. In this area there is also a corresponding radial extension, on which an external toothing (not shown in more detail) is arranged, with which an electric machine (not shown in more detail) is directly coupled to its output, so that any torque supplied by the electric machine can be provided directly to the drive gear 12; for example, if a torque increase is desired.

As described above, the internal toothing 10 and the external toothing 11 mesh, which means that their flanks rest against one another when torque is transmitted. The torque introduced via the crankshaft into the primary side 3 is dampened via the spring elements 5, provided from the primary side 3 to the secondary side 6 and transmitted via the drive gear 12 to the downstream drive component, i.e., here the transmission input shaft. This means that due to the coupling via the spring elements 5, the secondary side 6 can be rotated relative to the primary side 3 in the circumferential direction. This in turn means that there is no permanent flank contact within the meshing inner and outer toothings 10, 11, but there can be operating states in which the flanks separate from one another or there is a flank change, which can lead to noise being generated.

In order to avoid or suppress noise generation, a clamping ring 14 is provided according to the disclosure, which is integrated into the rotary damper 2. The clamping ring 14, which is made of spring steel or of a tempered steel, for example, depending on the desired bias to be generated via it, has a radially extending annular flange 15 via which it is fastened to the carrier 7, also via the riveted joints 9, like the output gear 8. A plurality of individual fingers 17 extend axially from the annular flange 15 in the direction of the end face 18 of the drive gear 12. These fingers 17 are assigned cut-outs 19 formed in the end face 18 of the drive gear 12, which extend axially and into which the fingers 17 engage. The arrangement is such that when the fingers 17 are inserted or in the assembly position within the cut-outs 19, the fingers 17 are slightly bent, so that a torsional bias is generated in the circumferential direction, via which the flanks of the external toothing 11 are biased against the flanks of the internal toothing 10 in the circumferential direction.

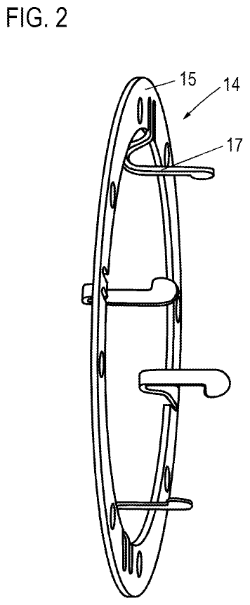

The clamping ring 14 is shown in detail in perspective in FIG. 2. In the example shown, four fingers 17 are connected to the annular flange 15, which are designed in one piece with the annular flange and are bent accordingly, such that they extend axially and nevertheless a certain deformation with bending in the circumferential direction is possible.

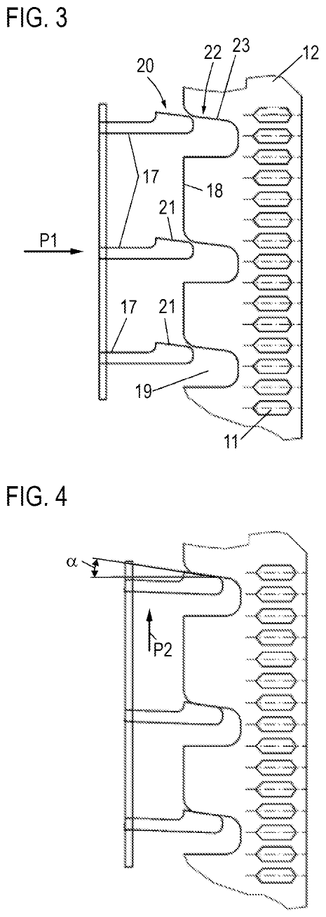

FIG. 3 shows the situation when the internal toothing 10 is pushed onto the external toothing 11. The plane of the fingers 17 and the cut-outs 19 is shown here. As can be seen, the fingers 17 are slightly offset from the center of the cut-outs 19 in the circumferential direction. The fingers 17 have contact surfaces 20 which have corresponding inclined surfaces 21. The cut-outs 19 also have contact surfaces 22, which also have inclined surfaces 23 in the example shown. The angle that the inclined surfaces 21 and 23 assume relative to the longitudinal axis is shown in FIG. 4 with the angle α. If the fingers 17 are now inserted into the cut-outs 19, as shown by the arrow P1 in FIG. 2, the inclined surfaces 21 slide on the inclined surfaces 23, a slight deformation or bending of the elongated, axially extending fingers 17 occurs, as shown in FIG. 3, and thus a bias is produced in the circumferential direction, directed in the direction of the arrow P2, i.e., the two inclined surfaces 21 and 23 are tensioned against each other in the circumferential direction. Due to this bias, the circumferential backlash between the internal and external toothings 10, 11 is now bridged and thus a permanent flank contact is realized, i.e., via the bias, it is prevented that the flanks lift off from each other too frequently, although this is of course not impossible in certain operating conditions. At the same time, noise can be reduced due to the almost permanent flank contact provided by the bias.

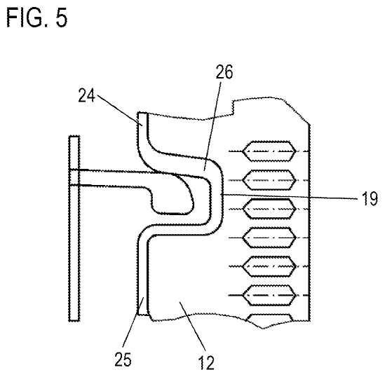

In certain operating states, an edge change can nevertheless occur. Therefore, the fingers or the flanks of the cut-out must be protected against wear. An example embodiment, see FIG. 5, provides for a plastic covering 24 to be applied to the end face of the drive gear 12 in the example shown, wherein this plastic covering 24 is, for example, a pressed-on or glued-on plastic ring 25 having corresponding sections 26 which completely line the cut-outs 19 here. This plastic covering 24 serves as protection against wear with regard to the finger grip. As an alternative to the illustrated design or arrangement of the plastic covering 24 on the drive gear 12, it is also conceivable to provide the respective fingers 17 with a corresponding plastic covering.

This means that the integration of the clamping ring 14 according to the disclosure in connection with the mechanical engagement of the fingers 17 in the cut-outs 19 on the drive gear results in a permanent bias on the meshing of the internal and external toothing 10, 11, which leads to a noise reduction.

### REFERENCE NUMERALS

1 Rotary damper device

2 Rotary damper

3 Primary side

4 Spring channel

5 Spring element

6 Secondary side

7 Carrier

8 Output gear

9 Rivet connection

10 Inner toothing

11 Outer toothing

12 Drive gear

13 Rolling bearing

14 Clamping ring

15 Annular flange

17 Finger

18 End face

19 Cut-out

20 Contact surface

21 Inclined surface

22 Contact surface

23 Inclined surface

24 Plastic covering

25 Plastic ring

26 Section lining cut-out

P1, P2 Arrow

1. A rotary damper device, comprising a rotary damper having an internally toothed output gear; and an externally toothed input gear of a drive component, which drive component is downstream of the rotary damper, wherein the output gear meshes with the input gear; wherein the rotary damper has a plurality of spring elements arranged on an annular carrier, wherein the rotary damper comprises a clamping ring, which has a plurality of axially extending fingers, which engage in axially open cut-outs in the input gear and thus clamp the input gear against the output gear.

2. The rotary damper device according to claim 1, wherein the clamping ring has a radially outwardly extending annular flange via which it is fastened to the carrier by means of fastening elements.

3. The rotary damper device according to claim 2, wherein the annular flange is fixed to the carrier via a plurality of fastening elements, in particular rivet or screw connections, via which the carrier is connected to the output gear.

4. The rotary damper device according to claim 1, wherein the fingers and the cut-outs have contact surfaces directed in the circumferential direction, which contact one another to produce a preload.

5. The rotary damper device according to claim 4, wherein the contact surfaces of the fingers or the contact surfaces of the cut-outs have inclined surfaces directed in the circumferential direction.

6. The rotary damper device according to claim 1, wherein the clamping ring is made of spring steel or tempered steel.

7. The rotary damper device according to claim 1, wherein the fingers or the cut-outs are provided at least in sections with a plastic covering.

8. The rotary damper device according to claim 7, wherein the plastic covering is applied to the fingers or the cut-outs as a covering, or the plastic covering is provided on the cut-outs in the form of a pressed-on plastic ring which has sections lining the cut-outs.

9. A rotary damper device, comprising:
a drive component comprising:
an input gear comprising:
an external toothing; and
axially open cut-outs; and
a rotary damper upstream of the drive component, the rotary damper comprising:
an annular carrier;
a spring element arranged in the annular carrier;
an output gear comprising an internal toothing meshed with the external toothing; and
a clamping ring comprising a plurality of axially extending fingers engaged in the axially open cut-outs to clamp the output gear against the input gear.

10. The rotary damper device of claim 9 further comprising fastening elements, wherein:
the clamping ring further comprises an annular flange extending radially outwardly; and
the annular flange is fastened to the annular carrier by the fastening elements.

11. The rotary damper device of claim 10, wherein the annular carrier is fastened to the output gear by the fastening elements.

12. The rotary damper device of claim 9, wherein:
the axially extending fingers comprise first contact surfaces directed in a circumferential direction; and
the axially open cut-outs comprise second contact surfaces directed in the circumferential direction that contact the first contact surfaces to produce a preload that clamps the output gear against the input gear.

13. The rotary damper device of claim 12, wherein:
the first contact surfaces comprise first inclined surfaces directed in the circumferential direction; or
the second contact surfaces comprise second inclined surfaces directed in the circumferential direction.

14. The rotary damper device of claim 9 wherein the clamping ring is made of spring steel or tempered steel.

15. The rotary damper device of claim 9 further comprising a plastic covering that covers a section of the axially extending fingers or the axially open cut-outs.

16. The rotary damper device of claim 15, wherein
the plastic covering is applied to the axially extending fingers or the axially open cut-outs as a covering; or
the plastic covering is a pressed-on plastic ring that lines the axially open cut-outs.
